(19) United States
(12) Patent Application Publication
(10) Pub. No.: US 2023/0278924 A1
(43) Pub. Date: Sep. 7, 2023

(54) INORGANIC PANELS WITH VOLCANIC ROCK BASED REINFORCEMENT AND METHODS FOR MAKING SAME

(71) Applicant: UNITED STATES GYPSUM COMPANY, Chicago, IL (US)

(72) Inventors: Ashish DUBEY, Grayslake, IL (US); Sundararaman Chithiraputhiran, Vernon Hills, IL (US)

(73) Assignee: UNITED STATES GYPSUM COMPANY, Chicago, IL (US)

(21) Appl. No.: 18/064,106

(22) Filed: Dec. 9, 2022

Related U.S. Application Data
(60) Provisional application No. 63/315,574, filed on Mar. 2, 2022.

(51) Int. Cl. C04B 20/00; C04B 41/00; C04B 14/18; C04B 20/10

(52) U.S. Cl. CPC C04B 20/0048; C04B 41/009; C04B 14/18; C04B 20/1029; C04B 2111/00612

(57) ABSTRACT

A cementitious panel system reinforced on its opposed surfaces by a fabric of basalt fiber woven or non-woven mesh. Preferably the mesh is a woven basalt scrim with thicker yarn and larger mesh openings to provide a cementitious panel with improved handling properties while retaining tensile strength and long term durability. The fabric is constructed as a mesh of high modulus strands of bundled basalt fibers. The fabric also has suitable physical characteristics for embedment within the cement matrix of the panels or panels closely adjacent the opposed faces thereof. The fabric provides a panel system with long-lasting, high strength tensile reinforcement and improved handling properties regardless of their spatial orientation during handling. Included as part of the invention are methods for making the reinforced cementitious panel.

### FIELD OF THE INVENTION

This invention relates to building products comprising inorganic cementitious panels (boards) strengthened with volcanic rock based reinforcement. The volcanic rock based reinforcement is produced using naturally occurring basalt rock. In particular, the cementitious panels include basalt-fiber as reinforcement.

### BACKGROUND OF THE INVENTION

U.S. Pat. No. 4,916,004 to Ensminger et al., incorporated herein by reference, discloses a cement board having bare surfaces and a mesh of reinforcing fibers underlying the top, bottom, and longitudinal edge surfaces is made continuously on an improved apparatus which comprises a pair of edger rails which slidably rest on a conveyor belt and define the path of the cement board being made on the conveyor belt and a means for folding and pressing outer margins of the bottom mesh into the edge surfaces and the top surface.

U.S. Pat. No. 8,298,332 B2 to Dubey, incorporated herein by reference, discloses fast setting of cementitious compositions and methods for making same. The cementitious compositions include 35-60 wt. % cementitious reactive powder (also termed Portland cement-based binder), 2-10 wt. % expanded and chemically coated perlite filler, 20-40 wt. % water, entrained air, and optional additives such as water reducing agents, chemical set-accelerators, and chemical set-retarders. In addition, the lightweight cementitious compositions may contain 0-25 wt. % on a wet basis secondary fillers such as expanded clay, shale aggregate, and pumice.

U.S. Patent Application Publication No. 2012/0148806 A1 to Dubey, incorporated herein by reference, discloses a cementitious board system which is reinforced on its opposed surfaces by a glass fiber mesh scrim. The fabric is constructed as a mesh of high modulus strands of bundled glass fibers encapsulated by alkali and water resistant material, e.g. a thermoplastic material. The composite fabric also has suitable physical characteristics for embedment within the cement matrix of the panels or boards closely adjacent the opposed faces thereof. Also disclosed are methods for making the reinforced board.

U.S. Pat. No. 5,858,083 to Stay, et al. discloses cementitious binders include calcium sulfate beta-hem ihydrate, a cement component comprising Portland cement, and either silica fume or rice-husk ash. The silica fume or rice-husk ash component is at least about 92 wt % amorphous silica and has an alumina content of about 0.6 wt % or less. A slurry of the binder/aggregate (and/or fiber), for forming the core of a board, may be poured onto a lower, continuous cover sheet which is disposed on a conveyor. Then, an upper continuous cover sheet is placed on the core as it moves on the conveyor. The cover sheets are preferably made from fiberglass matt, fiberglass scrim, or a composite of both. The cover sheets may also be non-woven or woven materials, such as polyethylene, polypropylene or nylon. As the slurry sets, scrim and mat are imbedded into the slurry matrix during the forming process.

U.S. Pat. No. 3,736,162 to Chvalovsky et al discloses cements containing mineral fibers. The mineral fibers include basalt (col. 2, lines 47-48). The cement can be Portland cement (col. 5, lines 55-66).

US Patent Application Publication No. 2002/0058576 A1 to Mazany et al. discloses a modified alkali silicate composition for forming an inorganic network matrix. An inorganic matrix composite can be prepared by applying a slurry of the modified aqueous alkali silicate composition to a reinforcing medium and applying the temperature and pressure necessary to consolidate the desired form. The composite can be shaped by compression molding as well as other known fabrication methods. Paragraph [0086] discloses that a reinforcing medium can be a material composed of reinforcing fibers, such as continuous or discontinuous fibers, which will be encapsulated in the matrix material. Reinforcing fibers may include glass fibers, carbon fibers, graphite fibers, metallic fibers, quartz fibers, ceramic fibers, basalt fibers, silicon carbide fibers, stainless steel fibers, titanium fibers, nickel alloy fibers, polymeric fibers, aramid fibers, alkaline resistant glass fibers and/or other fibers known to those knowledgeable in the arts. Reinforcing fibers may be in many forms, including yarns, tows, whiskers, continuous fibers, short fibers, woven fabrics, knitted fabrics, non-woven fabrics, random mats, felts, braided fabrics, wound tows, and/or other forms known to those knowledgeable in the arts.

Conventionally, structures have been reinforced with fabrics made of glass fibers. For example, it is known to improve the strength of border edge regions of a cement board by wrapping a glass fabric, covering one of the major surfaces of the board, around the edge to overlay the glass fabric on the other opposite major surface thereof. U.S. Pat. No. 4,916,004 to Ensminger discloses a cement board having a woven mesh of glass fibers immediately below each major surface thereof, the mesh in one major surface continuing under the surface of both longitudinal edge faces, with the two meshes in an abutting or an overlapping relation along the longitudinal margins of the opposite face. Additional patents disclosing edge reinforcement include U.S. Pat. No. 5,221,386 to Ensminger and U.S. Pat. No. 5,350,554 to Miller. U.S. Pat. No. 4,504,533 to Altenhofer discloses a gypsum board in which a composite web of a non-woven fiberglass felt and a woven fiberglass mat covers the upper and lower faces of a gypsum core while only the lower non-woven fiberglass felt is wrapped around the longitudinal edges of the gypsum core so that the non-woven fiberglass felt extends partially inward on the upper face of the core such that the border edge regions are covered only by non-woven fiberglass felt. Ordinary glass fabric must be covered with a protective finishing material that is pH neutral, that is, neither strongly alkaline nor acidic. Many alkaline or acidic materials, including cementitious materials such as mortar and concrete, degrade glass and weaken it. For this reason, structural reinforcing systems that include glass fiber fabric also typically include a finishing layer of epoxy or polyurethane, which is substantially neutral.

Basalt is an igneous mineral ore that can be melted and formed into continuous fibers, staple fibers, e.g., 30 mm in length, micro fibers of, for example, 0.42 μm in diameter, and intermediate lengths and diameters. Basalt fibers have been (a) used to make papermaking fabric, see U.S. Pat. No. 5,925,221 to Sayers et al.; (b) zirconia coated for alkali resistance, see J. Mater. Res., Vol. 9, No. 4, p. 1006 (1966); (c) used for internally reinforcing cement in concrete, see U.S. Pat. No. 4,304,604 to Daerr et al.; to reinforce thermosetting resins, particularly epoxy resins and polyester resins, see Popular Plastics, February, 1982, pages 6-8; and (d) formed from a melt of both glass and basalt rock, UK published application 2,019,386 A (1979) to Sidney et al.

U.S. Patent Application Publication No. 2002/0090871 A1 to Ritchie et al. discloses a cementitious panel having a basalt fiber-containing reinforcing web embedded in at least one major surface, preferably both major surfaces, of the panel. The basalt fibers-containing reinforcing webs preferably are in the form of a mesh or scrim comprising spaced basalt fiber strands in both the warp and fill directions, each strand made from a plurality of aligned, continuous basalt fibers. The basalt fiber reinforcing webs also can be in the form of woven or non-woven fabrics of basalt fibers, having aligned or randomly oriented staple and/or micro fibers, so long as the fabrics have sufficient void area to permit a cementitious core material to penetrate the fabric when the fabric is embedded in one or both major surfaces of the cementitious panel before the cementitious core material harden.

However, a need exists for cementitious boards with improved alkali resistance and performance.

### SUMMARY OF THE INVENTION

An objective of the invention is to furnish a cementitious panel containing a basalt fiber mesh reinforcement embedded on the panel surface. The basalt fiber mesh reinforcement can be woven or non-woven fabrics of basalt fibers. Chopped basalt fibers can be optionally added.

In its product respects the present invention provides a reinforced cementitious panel having an overall board density of about 40 to 80 pounds per cubic foot (0.64 to 1.28 g/cc), preferably about 45 to 65 pounds per cubic foot (0.72 to 1.04 g/cc), comprising:
a core layer of cementitious material having opposed planar surfaces and opposed edges and having a continuous phase resulting from the setting of an aqueous cementitious slurry having a pH greater than 9, comprising:
20-40 weight % water,
35-60 weight %, preferably 35-55 weight %, inorganic cement based binder, preferably Portland cement-based binder,
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice;
10-50 volume % entrained air, and
optionally, typically 0 to 10 wt. %, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
at least one outer layer of an woven or non-woven basalt fiber mesh reinforcement embedded in the opposed planar surfaces of the core layer,
wherein the basalt fiber mesh reinforcement is made from an uncoated basalt yarn or a coated basalt yarn,
wherein the uncoated basalt yarn consists essentially of basalt yarns and has a linear mass density in a range of 60 to 1200 Tex (grams per 1000 meters), and
wherein the coated basalt yarn comprises the basalt fibers and a coating on the basalt fibers, wherein the basalt fibers have a linear mass density of 60 Tex to 1200 Tex (mass in grams per 1000 meters), and the coated basalt yarn comprises 50 to 70 wt. % coating, preferably 15 to 30 wt % coating, on a dry basis;
wherein the number of basalt yarns per inch in the cement panel is 2-8 yarns/inch in warp direction and 2-8 yarns/inch in weft direction.

The preferred flexural strength of the panels of the invention ranges between 250 to 2000 psi (1.72 to 13.8 MPa), preferably 400 to 2000 psi (2.76 to 13.8 MPa), most preferably 750 to 1750 psi (5.17 to 12.1 MPa). The preferred maximum deflection of panels, measured in a flexural test conducted per ASTM C 947 for specimen tested over 10 inch span, made from this composition ranges between 0.25 to 1.75 inches (0.64 to 4.5 cm). The most preferred maximum deflection ranges between 0.50 to 1.25 inches (1.3 to 3.18 cm).

It is another object of the present invention to provide lightweight cementitious panels using basalt fiber mesh reinforcement that on a ½ inch (1.27 cm) thickness basis weigh preferably less than 3300 pounds per 1000 sq.ft. (16.1 kg per sq. m), more preferably less than 2500 pounds per 1000 sq.ft. (12.2 kg per sq. m), and most preferably less than 2100 pounds per 1000 sq.ft. (10.25 kg per sq. m).

It is another object of the present invention to provide cementitious panels using basalt fiber mesh reinforcement that are used as durable and bondable substrate for installation of ceramic tiles, dimensional stones, and plaster finishes.

It is another object of the present invention to provide cementitious panels using basalt fiber mesh reinforcement that have good water repellency and resistance to water penetration.

It is another object of the present invention to provide lightweight cementitious products using basalt fiber mesh reinforcement that have good handling, installation, and fastening characteristics.

It is another object of the present invention to provide lightweight cementitious panel products with good bond between the cementitious core and the basalt fiber mesh reinforcement during and after manufacturing.

It is another object of the present invention to provide methods for preparing lightweight cementitious compositions for manufacturing cement-based panels and building products using basalt fiber mesh reinforcement.

In its method respects the invention provides a method of making a cementitious panel comprising,
forming an aqueous cementitious slurry having a pH greater than 9, by mixing, typically under conditions which provide an initial slurry temperature of at least about 40° F. (4.4° C.):
20-40 weight % water,
35-60 weight %, preferably 35-55 weight %, inorganic cement based binder, preferably Portland cement-based binder,
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice;
10-50 volume % entrained air, and
optionally, typically 0 to 10 wt. %, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
placing a basalt fiber mesh reinforcement on a surface,
depositing the aqueous cementitious slurry on the basalt fiber mesh reinforcement on the surface by pouring the aqueous cementitious slurry through the basalt fiber mesh reinforcement to coat and embed the entire basalt fiber mesh reinforcement in the cementitious slurry before the aqueous cementitious slurry is set to form a core layer; and
setting the aqueous cementitious slurry to form the core layer, wherein the core layer has opposed planar surfaces and opposed edges, and at least one outer layer of said basalt fiber mesh reinforcement embedded between the opposed planar surfaces;
wherein the basalt fiber mesh reinforcement is made from an uncoated basalt yarn or a coated basalt yarn,
wherein the uncoated basalt yarn consists essentially of basalt fibers and has a linear mass density of 60 Tex to 1200 Tex (mass in grams per 1000 meters), and
wherein the coated basalt yarn comprises the basalt fibers and a coating on the basalt fibers, wherein the basalt fibers have a linear mass density of 60 Tex to 1200 Tex (mass in grams per 1000 meters), and wherein the coated basalt yarn comprises 50 to 70 wt. % coating, on a dry basis;
wherein the number of basalt yarns per inch in the cement panel is 2-8 yarns/inch in warp direction and 2-8 yarns/inch in weft direction.

Typically the aqueous cementitious slurry is mixed under conditions which provide an initial slurry temperature of at least about 40° F. (4.4° C.). Initial slurry temperature is defined as temperature right after completion of mixing, typically within five minutes of mixing all the slurry ingredients.

Typically, a cement panel made by setting (curing) the above-described composition using basalt-fiber as reinforcement has a thickness of about ¼ to 1 inch (6.3 to 25.4 mm). The cementitious panels of the present invention typically include edge reinforcement.

All percentages, ratios and proportions herein are by weight, unless otherwise specified. Also, any average molecular weights are weight average molecular weight unless specified otherwise. Where this specification refers to a dry basis, this is a water free basis. Where the specification refers to a wet basis, this is a water inclusive basis.

A practical use of the invention is to develop cementitious panel containing a basalt fiber reinforcing mesh embedded on the panel surface. The cementitious products produced using basalt-fiber as reinforcement will have significantly improved handling, installation, and fastening characteristics. Also the cement panel produced using basalt fibers will have improved score and snap performance and cutting characteristics.

### BRIEF DESCRIPTION OF THE DRAWING

FIG. 1 is a cross-section of the cement panel of this invention with a scrim layer embedded in the core on the top side of the cement core and, optionally embedded on the opposed side of the core.

FIG. 1A is a perspective view of a cement panel of this invention with a woven basalt mesh scrim layer, having a plain woven weave pattern, embedded in the core on the top side of the cement core and, optionally embedded on the opposed side of the core, in accordance with an embodiment of the present invention.

FIG. 1B is a diagram of a non-woven construction pattern for a basalt mesh scrim for use in making a reinforced cementitious panel of the present invention.

FIG. 2 is a diagrammatic side view of an example of a continuous manufacturing line for producing a cementitious panel of the invention using a basalt mesh scrim fabric.

FIG. 3 shows uncoated basalt yarns epoxied on the edges with tensile failure of the filaments in the non-epoxy portion.

FIG. 4 shows uncoated basalt mesh before cement panel cast.

FIG. 5 shows cement panel made using uncoated basalt roving.

FIG. 6 shows the coated basalt mesh before the cement panel was cast.

FIG. 7 shows the cement panel made using the coated basalt mesh.

### DETAILED DESCRIPTION OF THE INVENTION

Cement Panel

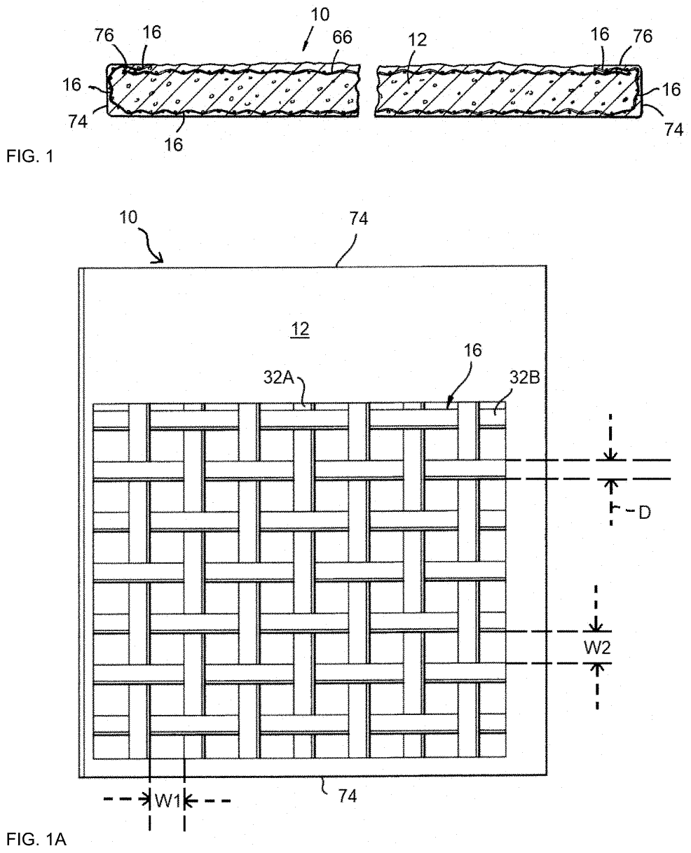

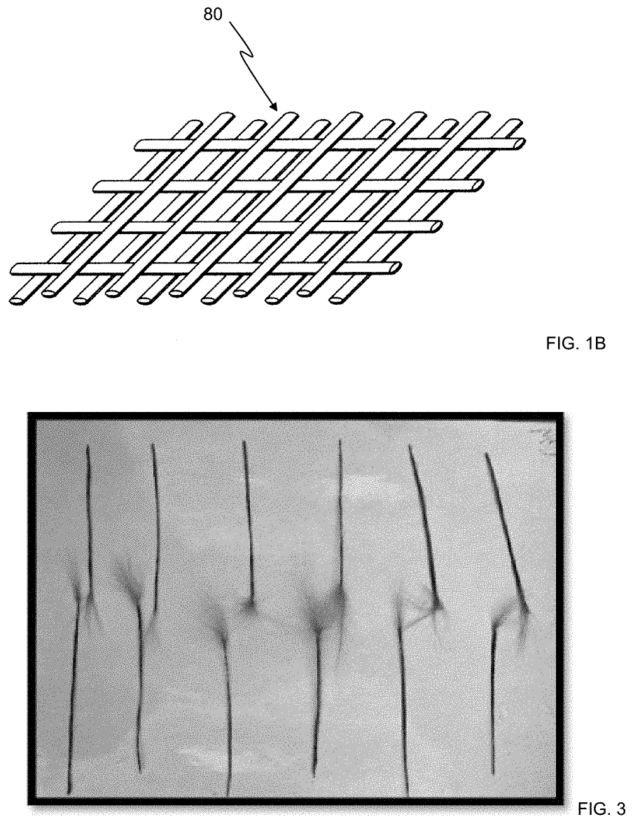

A typical cement panel 10 of the invention is shown in cross-section in FIG. 1 to reveal a core 12 which extends through the bottom basalt mesh 16 even as the basalt mesh bends up and around to overlap the top basalt mesh 66 which lies just beneath the upper surface of the panel. Thus, the cementitious material in the cement panel 10 is an autogenous binder for the lapping meshes 16 and 66 at the margins 76 of the upper surface of the panel. As shown, the edges 74 and the margins 76 are smooth because of the smoothing effect of carrier sheet strips being pressed onto the mix by rails and spatulas of a cement panel production line, as for example shown in U.S. Pat. No. 4,916,004 to Ensminger et al. The smooth margins 76 are preferred when the cement panels are fastened side-by-side on a partition and joint tape is adhesively applied to the margins before joint compound is applied. Although FIG. 1 shows the folded bottom basalt mesh 16 overlying the woven top basalt mesh 66 along the margins, the panel of this invention may be made so that the folded basalt mesh 16 lies under the top mesh 66. Moreover, although the cement panel having the top mesh 66 is described, it will be understood that the top mesh is not essential to this invention. In the invention the mesh scrim is typically embedded between about 0.03 to about 0.06 inches into at least one of the planar surface of the cement core layer.

Because of its cementitious nature, a cement panel (board) may have a tendency to be relatively brittle at its edges which often serve as points of attachment for the panels. Thus, optionally the edges 74 may be provided with additional basalt mesh reinforcement (not shown) or an alternate reinforcing material, or a combination thereof. For example, the basalt mesh reinforcement can be wrapped around edges 74. The reinforcement is embedded in the cementitious core.

Cementitious Composition

The word “cementitious” as used herein refers to any material, substance or composition containing or derived from a hydraulic cement such as, for example, portland cement and/or gypsum (calcium hem ihydrate). The term “slurry” is to be understood as referring to a flowable mixture, e.g., a flowable mixture of water and a hydraulic cement. The term “core layer” is to be understood as referring to a layer resulting from the setting of aqueous cementitious slurry.

Aqueous cementitious slurry compositions include:
20-40 weight % water,
35-60 weight %, preferably 35-55 weight %, inorganic cement based binder, preferably Portland cement-based binder,
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice;
10-50 volume % entrained air, and
optional additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents. The aqueous cementitious slurry has a pH greater than 9.

The cement based binder is cementitious reactive powder (for example Portland cement-based binder).

TABLE 1 describes preferred mixtures used to form the lightweight cementitious compositions of the present invention.

TABLE 1
Lightweight Cementitious Compositions

| Ingredient | Weight % | Volume % |
|---|---|---|
| Water | 20-40 | 20-40 |
| Portland cement-based binder | 35-60 | 10-25 |
| (cementitious reactive powder) | | |
| Chemically coated perlite | 2-10 | 7.5-40 |
| Expanded clay and shale aggregate | 0-25 | 0-15 |
| Entrained Air | — | 10-50 |

The volume occupied by the chemically coated perlite is in the range of 7.5 to 40%. and the volume occupied by the entrained air is in the range of 10 to 50% of the overall volume of the composition. Employing (i) lightweight filler and (ii) air entrainment significantly assists in producing cement products having the desired low density of about 40 to 80 pcf (0.64 to 1.28 g/cc), preferably about 45 to 65 pounds per cubic foot (0.72 to 1.04 g/cc). Air-entrainment in the compositions of the invention is provided by means of suitable surfactants that form a stable and uniform structure of air voids in the finished product.

The core layer of cementitious material has opposed planar surfaces and opposed edges and has a continuous phase resulting from the setting of an aqueous cementitious slurry having a pH greater than 9, preferably comprising:
20-40 weight % water;
35-60 weight % inorganic cement based binder (also known as cementitious reactive powder) comprising Portland cement and optionally a pozzolanic material (a typical mix included 100 parts Portland cement; 30 parts fly ash; 3 parts land plaster; expanded and chemically coated perlite filler (2-10% wt),
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice, wherein preferably the total of expanded and chemically coated perlite filler and secondary fillers typically selected from one or more of expanded clay, shale aggregate, and pumice is at least 20 wt %;
10-50 volume % entrained air (as volume % of the composite volume, the % of composite volume being the volume % of the slurry on a wet basis); and
optionally, typically 0 to 10 wt.%, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents.

### Basalt Fiber Mesh Reinforcement

The woven or non-woven basalt fiber mesh reinforcement embedded in the opposed planar surfaces of the core layer is typically “slurry-pervious reinforcing mesh”. It may be a woven mesh (woven mesh scrim) or a non-woven mat. The term “slurry-pervious reinforcing mesh” is to be understood as characterizing a basalt fiber-containing mesh that is suitable for use in the preparation of a cementitious panel, particularly having a cement or gypsum cement core, by having openings in the mesh that are sufficiently large to permit penetration of a cementitious slurry or a slurry component of a core mix into and through the openings so as to permit mechanical bonding of the mesh to the core either by, for example, being cemented to the core or by being embedded in a face or surface of the core of a panel.

The word “woven” as used herein is to be understood as characterizing a material such as a reinforcing component (e.g., mesh, mat, fabric, tissue, scrim, or the like), as comprising fibers or filaments which are oriented; oriented fibers or filaments being disposed in an organized fashion.

The word “non-woven” as used herein is to be understood as characterizing a material such as a reinforcing component (e.g., mesh, mat, fabric, tissue, scrim, or the like), as comprising fibers or filaments which are oriented (as described above) or which are non-oriented; non-oriented fibers or filaments being disposed in random fashion.

The volcanic rock-based reinforcement is produced using naturally occurring basalt rocks found throughout the world.

Basalt is an inert rock found worldwide in abundance as solidified volcanic lava. Basalt is known for its thermal properties, strength, and durability. Basalt roving delivers exceptional properties when used in woven or non-woven form. Optionally basalt fibers in chopped form may also be present. Basalt has high resistance to corrosion, chemicals, alkaline, acid and solvents. It has very high temperature tolerance and it maintains integrity at sustained temperatures up to 1800° F.

Basalt has very low elongation under the application of load and it can easily be manufactured in various Tex. Tex is a unit of measure for the linear mass density of fibers, yarns and thread and is defined as the mass in grams per 1000 meters. The preferred Tex of basalt fibers used in the present invention is in the range of 60 Tex to 1200 Tex, more preferably between 80 Tex to 600 Tex, most preferably between 100 Tex to 300 Tex.

The preferred number of basalt yarns per inch in the cement panel is 2-8 yarns/inch, more preferably 2-6 yarns/inch, most preferably 2-5 yarns/inch, in warp and weft directions.

Basalt yarns of the current invention may be made of oriented or non-oriented basalt fibers.

Basalt yarns of the current invention may be coated or uncoated. Basalt yarns may be coated with epoxy, PVC, acrylic, rubber, or any other polymer-based coating. A preferred amount of coating on the basalt fibers ranges from 50 to 70 wt %, more preferably from 30 to 50 wt %, and most preferably from 15 to 30 wt. %. For example, for 100 parts by weight of coated basalt fiber that is 15 wt. % coating, there is 15 parts by weight coating and 85 parts by weight basalt fiber as substrate on which the coating is placed. The uncoated basalt yarn consists essentially of basalt fibers and has a linear mass density of 60 Tex to 1200 Tex (mass in grams per 1000 meters). The yarns are typically made from continuous basalt fiber or filament. The uncoated basalt yarn that consists essentially of basalt fibers typically contains basalt fibers, the yarns or fibers being possibly at least partly provided with a sizing agent.

For example, the basalt fiber mesh is made from basalt fiber yarn coated with an alkali resistant coating selected from the group consisting of wax, polyvinyl chloride, polyvinyl alcohol, polyvinyl acetate, polyester, acrylics, acrylonitrile, silicones, styrene-butadiene, polypropylene, epoxy and polyethylene and mixtures thereof.

A distinguishing feature of the present invention is that the basalt yarns of the invention require a lower amount of coating to achieve long-term durability performance in comparison to the conventional E-glass based reinforcing yarns typically used in producing cement panels. It has been discovered that the basalt fiber yarns of the present invention have superior alkali resistance compared to the E-glass yarns. With respect to the alkali resistance, the basalt fiber yarns of the present invention are particularly suitable when the pH of the cementitious binder is greater than 9.

TABLE 2 gives the typical properties of basalt roving that were used in this invention.

TABLE 2
Technical Data of Basalt Roving

| | |
|---|---|
| Thermal limits | −260° C./−436º F. to +982° C./1800º F. |
| Vitrification temperature | 1050° C./1922º F. |
| Melting temperature | 1450° C./2642º F. |
| Density | 2600 to 2800 kg/m³ |
| Filament diameter | 9 to 23 microns |

Some examples of producers of basalt fibers and basalt fiber based reinforcing meshes include Advanced Filament Technologies (Sudaglass), Allendale Fibertech, and MAFIC.

Preferably the basalt reinforcement is a woven mesh scrim. The scrim mesh size can generally be any mesh size. Mesh sizes are typically measured by yarns per square inch, and are given as a number x number value. For example, a scrim sheet can be anything from 2×2 to 8×8 in longitudinal and transverse (warp and weft) directions. For example, a scrim sheet can be 8×8, 7.5×7.5, 7×8, or 5×5 strands per inch construction, respectively. Preferably the basalt woven mesh scrim has 2×2, 3×3, 3×4, 4×4 to 6×6, for example, 5×6 or 6×5, strands per inch construction in longitudinal and transverse directions, respectively. Smaller numbers of yarns per square inch correspond to larger mesh sizes, and larger openings in the mesh.

There are different weaving patterns, with the most commonly used pattern being the plain weave, in which the warp (longitudinal) and weft (transverse) are aligned so they form a simple criss-cross pattern. Each weft thread crosses the warp threads by going over one, then under the next, and so on. The next weft thread goes under the warp threads that it neighbors went over, and vice-versa.

FIG. 1A schematically shows a perspective view of the cement panel 10 having the cement core 12 and partially exposing the bottom layer of woven mesh or scrim 16 wrapped about the core 12. FIG. 1A shows the bottom layer of woven mesh or scrim 16 as a typical plain weave mesh 16. The core layer 12 is made of the cementitious material. The reinforcing basalt fibers of the woven mesh or scriml6 are embedded in a surface layer of the cement panel 10. The scrim 16 has warp (lengthwise or longitudinal) basalt fiber yarns 32A and weft (lateral or transverse) 32B basalt fiber yarns. The scrim or mesh layer 16 commonly extends over the panel edges 74 and overlaps at least a portion of the top mesh or scrim (See FIG. 1) on the opposed side and is embedded in the cement core 12. The basalt fibers. 32A, 32B have a diameter “D”. The basalt fibers 32A have a spacing “W1”. The basalt fibers. 32B have a spacing “W2” that is the same or different as spacing “W1”.

Descriptions of the woven process can be found in “Production of backing Fabrics-Woven”, by G. A. Build, Don Brothers, Buist & Co. Ltd., and Low Brothers & Co. (Dundee) Ltd, Carpet Substrates, edited by Dr. Peter Ellis, pp 31-44, The Textile Trade Press, 1973. Another reference to the woven process can be found in “Textiles”, 4^{th} edition, by Norma Hollen and Jane Saddler, MacMillan Publishing Co., Inc. 1973.

In the non-woven process, there are no separate stages for coating and overlaying and attaching the yarn. The raw fiberglass yarns are overlayed, and are then transported through a coating bath, where the mesh picks up the coating. The coating then cures and bonds the yarns to form a mesh. The most common scrim construction of a non-woven mesh scrim is shown in FIG. 8. The first warp thread under a weft thread is followed by a warp thread above the weft thread. This pattern is repeated across the whole width. Two threads will always meet at the intersections. A diagram of a typical plain weave mat 80 is shown in FIG. 1B.

A woven fabric (woven mesh scrim) typically may be woven from basalt fibers having a diameter in the range of about 8 to about 10 mm with a fiber count of about 110 to about 150 picks/inch. The woven fabric should have sufficient porosity to facilitate embedded mat in a gypsum, cement, or gypsum cement core material.

The non-woven fabric and the woven fabric typically has a basis weight in the range of about 50 to about 250 grams/m², for example about 50 to about 200 grams/m².

Examples of a basalt fiber, major surface reinforcing woven mesh and a basalt fiber major surface reinforcing non-woven mat which may be used herein are as follows.

Woven Mesh Scrim

The woven mesh (woven mesh scrim) would contain 2 to 12 ends per inch in the warp direction. Also, the mesh would contain 2 to 12 ends per inch in the 2 to 12 ends per inch in the weft direction. The mesh would preferably have 2-8 ends/inch or less, more preferably 2-6 ends/inch or less, and most preferably, 2-4 ends/inch or less in both warp and weft directions. The number of yarns in the warp direction and weft directions may be the same or different. The yarn linear density in the present invention is 60 Tex to 1200 Tex. A preferred yarn linear density in the present invention is 68 text or higher, more preferably, 100 tex or higher, and most preferably 136 tex or higher. The mesh would have an initial tensile strength between 75 to 125 pounds in the warp direction, preferably 100 pounds, and 60 to 90 pounds in the weft (also known as fill) direction, preferably 85 pounds. The mesh would also have a bursting strength between 60 to 100 pounds per square inch, preferably 80 pounds per square inch.

Non-Woven Mat

The non-woven basalt fiber mat would contain randomly dispersed chopped fiber strands with a diameter between 8 microns to 12 microns, preferably 9 microns. The basalt mat with a binding agent would have a basis weight between 0.0102 to 0.051 pounds per square foot. This corresponds to 50 to 250 gsm (grams per square meter). Preferably the basalt mat with the binding agent would have a basis weight of 0.0200 pounds per square foot. This corresponds to 97.6 gsm (˜100 gsm) The mat would have machine direction tensile strength between 40 to 90 pounds per inch, preferably 70 pounds per inch. The mat web would contain enough porosity to enable the embedding process into the aqueous cementitious slurry.

Inorganic Cement Based Binder

The cementitious compositions of this invention are inorganic cement based binders made from cementitious reactive powder, preferably Portland cement-based binders, magnesium oxide-based binders, magnesium oxy-chloride-based binders, magnesium hydroxide-based binders, magnesium sulfate-based binders, magnesium carbonate-based binders, geopolymer-cement based binders, lime cement-based binders, calcium silicate-based binders, carbonated calcium silicate-based binders, calcium alum inate-cement binders, calcium sulfoaluminate-cement based binders and mixtures thereof. For purposes of this description a “material”-based binder, for example a Portland cement-based binder or a magnesium oxide-based binder is a binder having at least 25 wt. % of that material, for example 25 wt. % Portland cement or 25 wt. % magnesium oxide, respectively, on a dry (water-free) basis. In other words, that material is at least 25 parts by weight per 100 parts by weight of the inorganic cement based binder. The inorganic cement based binder used in the present invention is preferably composed of either pure Portland cement or a mixture of Portland cement and a suitable pozzolanic material such as fly ash or blast furnace slag. The inorganic cement based binder used in the present invention is preferably Portland cement-based binder wherein Portland cement is at least 25 weight percent of the inorganic cement based binder on a dry (water free) basis. In other words, preferably Portland cement is at least 25 parts by weight per 100 parts by weight of the inorganic cement based binder.

The cementitious reactive powder may also optionally contain one or more of calcium sulfate dihydrate (gypsum, landplaster or calcium sulfate dihydrate), calcium sulfate hem ihydrate (stucco or calcined gypsum), anhydrous calcium sulfate (anhydrite) and high alumina cement (HAC) added in dosages to influence setting and hydration characteristics of the cement based binder. High alumina cement (HAC) is typically less than 50 wt. %, more typically less than 40 or less than 30 wt. % of the inorganic cement based binder, on a dry basis, for example, less than 10 wt. %, on a dry basis. Calcined gypsum may be used in the current aqueous cementitious slurry formulations, and gypsum in the set cementitious cores, as long as the pH of the aqueous cementitious slurry and resulting set cementitious core, respectively, are greater than 9.0. In contrast, pure gypsum slurries and set cementitious cores of pure gypsum boards typically have pH less than 8.0. Typically to have pH greater than 9.0 the total gypsum (landplaster or calcium sulfate dihydrate), calcium sulfate hemihydrate (stucco or calcined gypsum), and/or anhydrous calcium sulfate (anhydrite) in the aqueous cementitious slurry formulations and set cementitious core formulations is at most 25 parts by weight gypsum and/or calcined gypsum per 100 parts by weight of the inorganic cement based binder.

Typically calcium sulfate hemihydrate is at most 25 wt. % of the inorganic cement based binder in the aqueous cementitious slurry on a dry basis. In other words, calcium sulfate hemihydrate is at most 25 parts by weight per 100 parts by weight inorganic cement based binder in the aqueous cementitious slurry. Typically calcium sulfate dihydrate is at most 25 wt. % of the inorganic cement based binder in the set cementitious core on a dry basis. In other words calcium sulfate dihydrate is at most 25 parts by weight per 100 parts by weight inorganic cement based binder in the set cementitious core on a dry basis.

The inorganic cement based binder (for example Portland cement-based binder) used in the present invention is typically composed of either pure Portland cement or a mixture of Portland cement and a suitable pozzolanic material such as fly ash or blast furnace slag.

The inorganic cement based binder typically includes Portland cement, and also may include high alumina cement, calcium sulfate, and a mineral additive, preferably fly ash, to form a slurry with water.

The inorganic cement based binder of the cementitious composition may contain high concentrations of mineral additives, such as pozzolanic materials, up to 60 wt %, typically up to 50 wt. %, of the inorganic cement based binder on a dry basis. Increasing the content of mineral additives, e.g. fly ash, would help to substantially lower the cost of the product. Moreover, use of pozzolanic materials in the composition helps enhance the long-term durability of the product as a consequence of the pozzolanic reactions. The mineral additives that are considered part of the inorganic cement based binder are active mineral additives, such as pozzolanic materials. Such active mineral additives form compounds possessing cementitious properties in the inorganic cement based binder. In contrast, inert materials, such as inactive mineral additives or aggregate, are inert and considered filler. The filler is not considered part of the inorganic cement based binder. The filler is an inert additional ingredient in the aqueous cementitious slurry and the set cementitious core resulting from the setting of the aqueous cementitious slurry.

When the inorganic cement based binder (cementitious reactive powder) includes only Portland cement and fly ash, the inorganic cement based binder preferably contains 40-90 wt. % Portland cement and 10-60 wt. % fly ash, or 40-80 wt. % Portland cement and 20-60 wt. % fly ash, wherein wt. % is based on the sum of the Portland cement and fly ash on a dry basis.

Preferably the fly ash, if present, is Class C fly ash.

When the inorganic cement based binder includes Portland cement and one or other ingredients such as gypsum (land plaster), high alumina cement, and/or fly ash, the inorganic cement based binder preferably contains 25-80 wt. % Portland cement, 0 to 25 wt. % calcium sulfate, 0 to 20 wt. % high alumina cement, and 0 to 55 wt. % fly ash based on the sum of these components on a dry basis.

The inorganic cement based binder may be free of externally added lime. Reduced lime content helps lower the alkalinity of the cementitious matrix and thereby increase the long-term durability of the product.

Hydraulic Cement

Hydraulic cements, in particular Portland cement, make up a substantial amount of the compositions of the invention. It is to be understood that, as used here, “hydraulic cement” does not include gypsum, which does not gain strength under water, although typically some gypsum is included in Portland cement. Typical cements that may be employed in the invention include Type I Portland cement, Type III Portland cement, and/or other hydraulic cements such as white cement, slag cements such as blast-furnace slag cement, pozzolan blended cements, expansive cements, sulfoaluminate cements, and oil-well cements.

ASTM C 150 standard specification for Portland cement defines Portland cement as a hydraulic cement produced by pulverizing clinker consisting essentially of hydraulic calcium silicates, usually containing one or more of the forms of calcium sulfate as an inter-ground addition. More generally, other hydraulic cements may be substituted for Portland cement, for example calcium sulfoaluminate cements. To manufacture Portland cement, an intimate mixture of limestone and clay is ignited in a kiln to form Portland cement clinker. The following four main phases of Portland cement are present in the clinker—tricalcium silicate (3CaO·SiO₂, also referred to as C₃S), dicalcium silicate (2CaO·SiO₂, called C₂S), tricalcium alum inate (3CaO·Al₂O₃ or C₃A), and tetracalcium aluminoferrite (4CaO·Al₂O₃·Fe₂O₃ or C₄AF). The resulting clinker containing the above compounds is inter-ground with calcium sulfates to desired fineness to produce the Portland cement.

The other compounds present in minor amounts in Portland cement include double salts of alkaline sulfates, calcium oxide, and magnesium oxide. When cement panels are to be made, the Portland cement will typically be in the form of very fine particles such that the particle surface area is greater than 4,000 cm²/gram and typically between 5,000 to 6,000 cm²/gram as measured by the Blaine surface area method (ASTM C 204). Of the various recognized classes of Portland cement, ASTM Type III Portland cement is most preferred in the cementitious reactive powder of the cementitious compositions of the invention. This is due to its relatively faster reactivity and high early strength development.

### Pozzolanic Mineral Additives

The cementitious reactive powder blend of the cementitious composition may contain high concentrations of mineral additives, such as pozzolanic materials (as part of the inorganic cement based binder).

ASTM C618-97 defines pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.” Various natural and man-made materials have been referred to as pozzolanic materials possessing pozzolanic properties. Some examples of pozzolanic materials include pumice, diatomaceous earth, silica fume, tuff, trass, rice husk, metakaolin, ground granulated blast furnace slag, and fly ash. All of these pozzolanic materials can be used either singly or in combined form as part of the cementitious reactive powder of the invention.

Fly ash is the preferred pozzolan in the cementitious reactive powder blend of the invention. Fly ashes containing high calcium oxide and calcium aluminate content (such as Class C fly ashes of ASTM C618 standard) are preferred as explained below. Other mineral additives such as calcium carbonate, clays, and crushed mica may also be included.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 standard recognizes two major classes of fly ashes for use in concrete—Class C and Class F. These two classes of fly ashes are derived from different kinds of coals that are a result of differences in the coal formation processes occurring over geological time periods. Class F fly ash is normally produced from burning anthracite or bituminous coal, whereas Class C fly ash is normally produced from lignite or sub-bituminous coal.

The ASTM C618 standard differentiates Class F and Class C fly ashes primarily according to their pozzolanic properties. Accordingly, in the ASTM C618 standard, the major specification difference between the Class F fly ash and Class C fly ash is the minimum limit of SiO₂+Al₂O₃+Fe₂O₃ in the composition. The minimum limit of SiO₂+Al₂O₃+Fe₂O₃ for Class F fly ash is 70% and for Class C fly ash is 50%. Thus, Class F fly ashes are more pozzolanic than the Class C fly ashes. Although not explicitly recognized in the ASTM C618 standard, Class C fly ashes typically contain high calcium oxide content. Presence of high calcium oxide content makes Class C fly ashes possess cementitious properties leading to the formation of calcium silicate and calcium aluminate hydrates when mixed with water. As will be seen in the examples below, Class C fly ash has been found to provide superior results, particularly in the preferred formulations in which high alumina cement and gypsum are not used.

The weight ratio of the pozzolanic material to the Portland cement in the cementitious reactive powder blend used in the cementitious composition of the invention may be about 0/100 to 150/100, preferably 25/100 to 125/100. For example, a typical cementitious reactive powder blend has about 10 to 60 wt. % fly ash and 40 to 90 wt. % Portland cement.

### High Alumina Cement

High alumina cement (HAC) is another type of hydraulic cement that may form a component of the reactive powder blend of some embodiments of the invention.

High alumina cement is also commonly referred to as aluminous cement or calcium aluminate cement. As the name implies, high alumina cements have a high alumina content, about 36-42 wt % is typical. Higher purity high alumina cements are also commercially available in which the alumina content can range as high as 80 wt %. These higher purity high alumina cements tend to be very expensive relative to other cements. The high alumina cements used in the compositions of some embodiments of the invention are finely ground to facilitate entry of the aluminates into the aqueous phase so that rapid formation of ettringite and other calcium aluminate hydrates can take place. The surface area of the high alumina cement that may be used in some embodiments of the composition of the invention will be greater than 3,000 cm²/gram and typically about 4,000 to 6,000 cm²/gram as measured by the Blaine surface area method (ASTM C 204).

Several methods have emerged to manufacture high alumina cement. Typically, the main raw materials for manufacturing high alumina cement are bauxite and limestone. One manufacturing method used in the US for producing high alumina cement is described as follows. The bauxite ore is first crushed and dried, then ground along with limestone. The dry powder comprising bauxite and limestone is then fed into a rotary kiln. A pulverized low-ash coal is used as fuel in the kiln. Reaction between bauxite and limestone takes place in the kiln and the molten product collects in the lower end of the kiln and pours into a trough set at the bottom. The molten clinker is quenched with water to form granulates of the clinker, which is then conveyed to a stock-pile. The granulate is then ground to the desired fineness to produce the final cement.

Several calcium aluminate compounds are formed during the manufacturing process of high alumina cement. The predominant compound formed is monocalcium aluminate (CA). The other calcium aluminate and calcium silicate compounds that are formed include C₁₂A₇, CA₂, C₂S, C₂AS. Several other compounds containing relatively high proportion of iron oxides are also formed. These include calcium ferrites such as CF and C₂F, and calcium alumino-ferrites such as C₄AF, C₆AF₂ and C₆A₂F. Other minor constituents present in the high alumina cement include magnesia (MgO), titanic (TiO₂), sulfates and alkalis. It should be noted that tri-calcium aluminate (C₃A) seen in ordinary Portland cement is not found in high alumina cements.

### Calcium Sulfate

Various forms of calcium sulfate as shown below may be used in the invention to provide sulfate ions for forming ettringite and other calcium sulfoaluminate hydrate compounds:
Dihydrate—CaSO₄·2H₂O (commonly known as gypsum)
Hemihydrate—CaSO₄·½H₂O (commonly known as stucco)
Anhydrite—CaSO₄ (also referred to as anhydrous calcium sulfate)

Land plaster is a relatively low purity gypsum and is preferred due to economic considerations, although higher purity grades of gypsum could be used. Land plaster is made from quarried gypsum and ground to relatively small particles such that the specific surface area is greater than 2,000 cm²/gram and typically about 4,000 to 6,000 cm²/gram as measured by the Blaine surface area method (ASTM C 204). The fine particles are readily dissolved and supply the gypsum needed to form ettringite. Synthetic gypsum obtained as a by-product from various manufacturing industries can also be used as a preferred calcium sulfate in the present invention. The other two forms of calcium sulfate, namely, hemihydrate and anhydrite may also be used in the present invention instead of gypsum, i.e., the dihydrate form of calcium sulfate.

### Aggregates and Fillers

While the disclosed cementitious reactive powder blend defines the rapid setting component of the cementitious composition of the invention, it will be understood by those skilled in the art that other materials may be included in the composition depending on its intended use and application.

The cementitious reactive powder blend of the cementitious composition may contain high concentrations of mineral additives, such non-pozzolanic aggregates (as filler in the overall blend), for example, calcium carbonate, mica, talc, etc.

For instance, for cement panel applications, it is desirable to produce lightweight panels without unduly comprising the desired mechanical properties of the product. This objective is achieved by adding lightweight aggregates and lightweight fillers. The cementitious compositions of this invention can also include a variety of light weight fillers and additives including expanded perlite, expanded clay and shale aggregate, ceramic microspheres, glass microspheres, slag aggregate, pumice aggregate, volcanic rock aggregates, aluminum powder, diatomaceous earth, polystyrene beads, expanded plastic beads, soap and mixtures thereof.

Pumice used as lightweight aggregate is a hydrated aggregate (filler) and not cement. In contrast, pumice used as pozzolanic mineral additive (describe in the above-listed section entitled “Mineral Additives”) is a non-hydrated form and falls within the ASTM C618-97 definition of pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.”

Depending on the choice of lightweight aggregate or filler selected, the weight ratio of the lightweight aggregate or filler to the reactive powder blend may be about 1/100 to 200/100, preferably about 2/100 to 125/100. For example, for making lightweight cement panels, the weight ratio of the lightweight aggregate or filler to the cementitious reactive powder blend may be about 2/100 to 125/100.

However, preferably the total of expanded and chemically coated perlite filler and secondary fillers, for example expanded clay, shale aggregate and/or pumice, is at least 20% wt.

In addition to the basalt mesh reinforcement discrete reinforcing fibers of different types, for example chopped basalt fibers, may also be included in the cementitious compositions of the invention. In addition to the basalt mesh reinforcement discrete scrims made of materials such as polymer-coated glass fibers and polymeric materials such as polypropylene, polyethylene and nylon may be used to reinforce the cement-based product depending upon its function and application.

A preferred filler is expanded perlite filler. Typical expanded perlite filler is coated with silane, siloxane, silicone or a mixture thereof. This expanded perlite filler is typically chemically coated for water-tightness and water repellency.

The expanded perlite filler is 2-10 weight %, 7.5-40 volume % of the cementitious composition slurry. The expanded perlite filler is composed of particles having a mean particle diameter typically between 20-500 microns or 20 to 250 microns, preferably between 20-150 microns, more preferably between 20-90 microns, and most preferably between 20-60 microns. The expanded perlite filler has an effective particle density preferably less than 0.50 g/cc, more preferably less than 0.40 g/cc and most preferably less than 0.30 g/cc, and chemically treated with silane, siloxane, silicone coatings or a mixture thereof. The most preferred chemical coating compounds for making perlite particles water-tight and water repellant are alkyl alkoxy silanes. Octyltriethoxy silane represents the most preferred alkyl alkoxy silane to coat perlite for using with the cementitious compositions of this invention.

A typical commercially available chemically coated perlite filler is SIL-CELL 35-23 available from Silbrico Corporation. SIL-CELL 35-23 perlite particles are chemically coated with alky alkoxy silane compound. Another typical chemically coated perlite filler is SIL-CELL 35-34 available from Silibrico Corporation. SIL-CELL 35-34 perlite particles are also useful in cementitious compositions of the invention and are coated with silicone compound. Other typical coated perlite fillers are DICAPERL 210, with alkyl alkoxy silane compound, and DICAPERL 220, coated with silicone compound, produced by Grefco Minerals Inc.

Another very useful property of the perlite fillers of the invention is that they display pozzolanic properties because of their small particle size and silica-based chemical nature. Owing to their pozzolanic behavior, the selected perlite fillers of the invention improve chemical durability of the cementitious composites while developing improved interfaces and enhanced bonding with the cementitious binders and other ingredients present in the mixture.

### Air-Entraining Agents (Foaming Agents)

When it is desired to produce the present lightweight products such as lightweight cement panels, air-entraining agents (foaming agents) may be added in the composition to lighten the product. Air-entrainment agents are generally suitable surfactants that form a stable and uniform structure of air voids in the finished product. Accordingly the slurry contains a suitable air entrainment or foaming agent in such amounts to produce the desired degree of air entrainment.

Typically air entraining agents or foaming agents are surfactants, provided in an amount from about 0.0015 to 0.03 wt. %, based upon the total slurry weight. More preferably, the weight of these surfactants ranges between 0.002 to 0.02 wt. %, based upon the total slurry weight. For example, sodium alkyl ether sulfate, ammonium alkyl ether sulfate, sodium alpha olefin sulfonate (AOS), sodium deceth sulfate, ammonium deceth sulfate, sodium laureth sulfate, or sodium dodecylbenzene sulfonate are suitable air entraining and foaming surfactants that can be used in the cementitious compositions of the invention.

In the cementitious compositions of the invention, externally produced foam is preferably used to reduce slurry and product density. The foam is prepared using suitable surfactants (foaming agents) together with water and air in proper proportions combined in foam generation equipment. The foam so produced is then introduced directly in to the wet mixture during the mixing operation while preparing cementitious slurry.

### Alkanolamines

In the present invention, different varieties of alkanolamines can be used alone or in combination to accelerate the setting characteristics of the cementitious composition of the invention. Alkanolamines are amino alcohols that are strongly alkaline and cation active. Triethanolamine [N(CH₂—CH₂OH)₃] is the preferred alkanolamine. However, other alkanolamines, such as monoethanolamine [NH₂(CH₂—CH₂OH)], diethanolamine [NH(CH₂—CH₂OH)₂] may be substituted for triethanolamine (TEA) or used in combination with TEA.

Addition of alkanolamine alone, or in addition to phosphate (described below), has a significant influence on the rapid setting characteristics of the cementitious compositions of the invention when initiated at elevated temperatures, for example a slurry temperature greater than 90° F. (32° C.). Typically the slurry has an initial temperature of about 90-150° F. (32-66° C.).

If used without phosphate the dosage of alkanolamine, preferably triethanolamine, employed as an accelerator in the slurry is typically about 0.025 to 4.0 wt. %, 0.05 to 2 wt. %, 0.05 to 1 wt. %, 0.05 to 0.40 wt. %, 0.05 to 0.20 wt. %, or 0.05 to 0.10 wt. % based on the weight of cementitious reactive powder.

Thus, for example, for every 100 pounds of cementitious reactive powder there is about 0.025 to 4.0 pounds of alkanolamine in the mixture.

### Phosphates

If desired, phosphates may optionally be used together with alkanolamine, e.g., triethanolamine, as an accelerator. Such phosphates may be one or more of sodium trimetaphosphate (STMP), potassium tripolyphosphate (KTPP) and sodium tripolyphosphate (STPP)

The dosage of phosphate is about 0 to 1.5 wt. %, or 0.15 to 1.5 wt. %, or about 0.3 to 1.0 wt. %, or about 0.5 to 0.75 wt. % based on the cementitious reactive components of the invention. Thus, for example, for 100 pounds of cementitious reactive powder, there may be about 0 to 1.5 pounds of phosphate.

The degree of rapid set obtained with the addition of an appropriate dosage of phosphate under conditions that yield slurry temperature greater than 90° F. (32° C.) allows a significant reduction of alkanolamine in the absence of high alumina cement.

### Retarders

Use of set retarders as a component in the compositions of the invention is particularly helpful in situations where the initial slurry temperatures used to form the cement-based products are particularly high, typically greater than 100° F. (38° C.). At such relatively high initial slurry temperatures, retarders such as sodium citrate or citric acid promote synergistic physical interaction and chemical reaction between different reactive components in the compositions resulting in favorable slurry temperature rise response and rapid setting behavior. Without the addition of retarders, stiffening of the reactive powder blend of the invention may occur very rapidly, soon after water is added to the mixture. Rapid stiffening of the mixture, also referred to here as “false setting” is undesirable, since it interferes with the proper and complete formation of ettringite, hinders the normal formation of calcium silicate hydrates at later stages, and leads to development of extremely poor and weak microstructure of the hardened cementitious mortar.

The primary function of a retarder in the composition is to keep the slurry mixture from stiffening too rapidly thereby promoting synergistic physical interaction and chemical reaction between the different reactive components. Other secondary benefits derived from the addition of retarder in the composition include reduction in the amount of superplasticizer and/or water required to achieve a slurry mixture of workable consistency. All of the aforementioned benefits are achieved due to suppression of false setting. Examples of some useful set retarders include sodium citrate, citric acid, potassium tartrate, sodium tartrate, and the like. In the compositions of the invention, sodium citrate is the preferred set retarder. Furthermore, since set retarders prevent the slurry mixture from stiffening too rapidly, their addition plays an important role and is instrumental in the formation of good edges during the cement panel manufacturing process. The weight ratio of the set retarder to the cementitious reactive powder blend generally is less than 1.0 wt. %, preferably about 0.04-0.3 wt. %.

### Inorganic Secondary Set Accelerators

In combination with the above-discussed alkanolamines and optional phosphates, other inorganic set accelerators may be added as inorganic secondary set accelerators in the cementitious composition of the invention.

Addition of these inorganic secondary set accelerators is expected to impart only a small reduction in setting time in comparison to the reduction achieved due to the addition of the combination of alkanolamines and optional phosphates.

Examples of such inorganic secondary set accelerators include a sodium carbonate, potassium carbonate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement panel fasteners is of concern.

The weight ratio of the secondary inorganic set accelerator to the cementitious reactive powder blend typically will be less than 2 wt %, preferably about 0.0 to 1 wt %. In other words, for 100 pounds of cementitious reactive powder there is typically less than 2 pounds, preferably about 0.0 to 1 pounds, of secondary inorganic set accelerator. These secondary set accelerators can be used alone or in combination.

### Other Additives and Ingredients

Other additives including water reducing agents such as superplasticizers, shrinkage control agents, slurry viscosity modifying agents (thickeners), coloring agents and internal curing agents, may be included as desired depending upon the processability and application of the cementitious composition of the invention.

Chemical additives such as water reducing agents (superplasticizers) may be included in the compositions of the invention and added in the dry form or in the form of a solution. Superplasticizers help to reduce the water demand of the mixture. Examples of superplasticizers include polynapthalene sulfonates, polyacrylates, polycarboxylates, lignosulfonates, melamine sulfonates, and the like.

Depending upon the type of superplasticizer used, the weight ratio of the superplasticizer (on dry powder basis) to the reactive cementitious powder typically will be about 2 wt. % or less, preferably about 0.1 to 1.0 wt. %, more preferably about 0.0 to 0.50 wt. %, and most preferably about 0.0 to 0.20 wt. %. Thus, for example, when superplasticizer is present in the range 0.1 to 1.0 wt. %, for every 100 pounds of cementitious reactive powder in the mixture, there may be about 0.1 to 1 pounds of superplasticizer.

Other chemical admixtures such as shrinkage control agents, coloring agents, viscosity modifying agents (thickeners) and internal curing agents may also be added in the compositions of the invention if desired.

### Manufacturing of Precast Concrete Products Such as Cement Panels

Precast concrete products such as cement panels are manufactured most efficiently in a continuous process in which the reactive powder blend is blended with aggregates, fillers and other ingredients, followed by addition of water and other chemical additives just prior to placing the mixture in a mold or over a continuous casting and forming belt.

Due to the rapid setting characteristics of the cementitious mixture the mixing of dry components of the cementitious blend with water usually will be done just prior to the casting operation. As a consequence of the formation of hydrates of calcium aluminate compounds and the associated water consumption in substantial quantities, the cement-based product becomes rigid, and ready to be cut, handled and stacked for further setting (curing).

Thus, the cementitious reactive composition of the invention is combined with a suitable amount of water to hydrate the cementitious reactive powder and to rapidly form ettringite and other hydrates of calcium aluminate compounds. Generally, the amount of water added will be greater than theoretically required for the hydration of the cementitious reactive powder. This increased water demand is allowed to facilitate the workability of the cementitious slurry. Typically, the weight ratio of the water to cementitious reactive powder blend (cement based binder) is about 0.20/1 to 0.80/1, preferably about 0.45/1 to 0.65/1. The amount of water depends on the needs of the individual materials present in the cementitious composition.

Ettringite and other hydrates of calcium aluminate compounds form very rapidly in the hydration process thus imparting rapid set and rigidity to the mixtures made with the reactive powder blend of the cementitious composition of the invention. In manufacturing of cement-based products such as cement panels, it is primarily the formation of ettringite and other calcium alum inate hydrates that makes possible handling of cement panels within a few minutes after the cementitious composition of the invention is mixed with a suitable amount of water.

Setting of the composition is characterized by initial and final set times, as measured using Gillmore needles specified in the ASTM C266 test procedure, as well as high initial compressive strength. The final set time also corresponds to the time when a cement-based product e.g. a cement panel, has sufficiently hardened so that it can be handled. It will be understood by those skilled in the art that curing reactions continue for extended periods after the final setting time has been reached.

The slurry is typically formed under conditions which provide an initially high slurry temperature. The initial slurry temperature should be at least about 40° F. (4.4° C.). For example, the initial slurry temperature may be at least about 90° F. (32° C.). Slurry temperatures in the range of 90° F. to 150° F. (32° to 66° C.) produce very short setting times. In general, within this range increasing the initial temperature of the slurry increases the rate of temperature rise as the reactions proceed and reduces the setting time. Thus, an initial slurry temperature of 95° F. (35° C.) is preferred over an initial slurry temperature of 90° F. (32° C.), a temperature of 100° F. (38° C.) is preferred over 95° F. (35° C.), a temperature of 105° F. (41° C.) is preferred over 100° F. (38° C.), a temperature of 110° F. (43° C.) is preferred over 105° F. (41° C.) and so on. It is believed the benefits of increasing the initial slurry temperature decrease as the upper end of the broad temperature range is approached.

As will be understood by those skilled in the art, achieving an initial slurry temperature may be accomplished by more than one method. Perhaps the most convenient method is to heat one or more of the components of the slurry. In the examples, the present inventors supplied water heated to a temperature such that, when added to the dry reactive powders and unreactive solids, the resulting slurry is at the desired temperature. Alternatively, if desired the solids could be provided at above ambient temperatures. Using steam to provide heat to the slurry is another possible method that could be adopted. Although not preferred, a slurry could be prepared at ambient temperatures and promptly heated to raise the temperature to about 90° F. or higher, where the benefits of the invention can be achieved. The initial slurry temperature is preferably about 120° F. to 130° F. (49° to 54° C.).

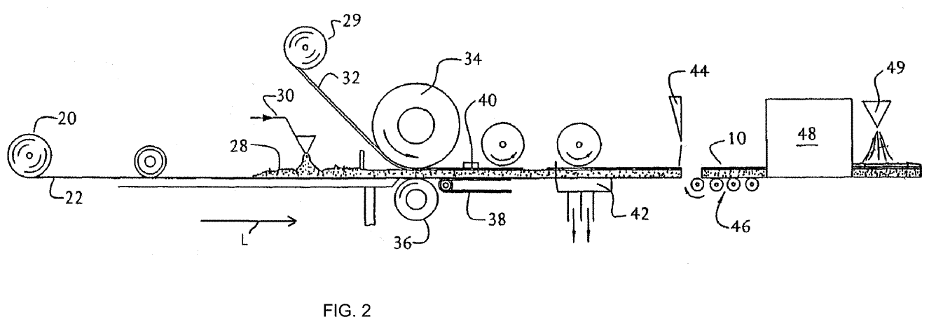

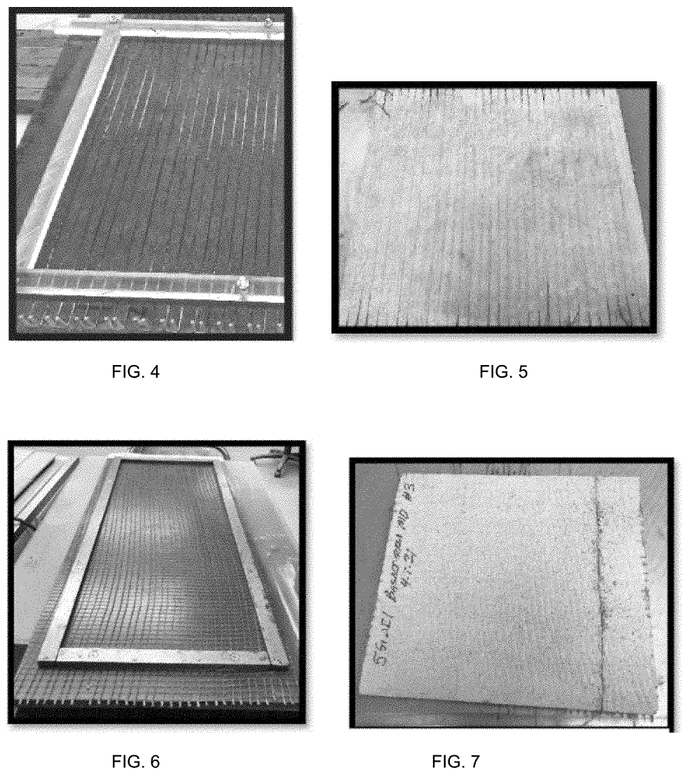

An attractive feature of the present invention is that the cementitious panel 10 can be made utilizing existing cement panel manufacturing lines, for example, as shown diagrammatically in FIG. 2. In conventional fashion, dry ingredients (not shown) from which the cementitious core 12 is formed are pre-mixed and then fed to a mixer of the type commonly referred to as a mixer 30. Water and other liquid constituents (not shown) used in making the core are metered into the mixer 30 where they are combined with the dry ingredients to form an aqueous cementitious slurry 28. Foam is generally added to the slurry in the mixer 30 to control the density of the resulting cementitious core 12.

A sheet of bottom basalt fiber fabric 22 is fed from the bottom basalt fiber fabric roll 20 onto a surface. The aqueous cementitious slurry 28 from the mixer 30 is deposited on bottom basalt fiber fabric 22. A sheet of top basalt fiber fabric 32 is fed from the top basalt fiber fabric roll 29 onto the top of the cementitious slurry 28, thereby sandwiching the slurry between the two moving fabrics which form the facings of the cementitious core 12 which is formed from the cementitious slurry 28. Typically the bottom basalt fiber fabric 22 sufficiently wider than the deposited slurry to wrap its lateral edges about the lateral edges of the deposited slurry as the slurry sets to form a cementitious core layer. The bottom and top basalt fabrics 22 and 32, with the cementitious slurry 28 sandwiched therebetween enter the nip between the upper and lower forming or shaping rolls 34 and 36 and are thereafter received on a conveyer belt 38.

Conventional wall panel (wallboard) edge guiding devices 40 shape and maintain the edges of the composite until the slurry has set sufficiently to retain its shape. Sequential lengths of the panel are cut by a water knife 44. The cementitious panel 10 is next moved along feeder rolls 46 to permit it to set. An additional sprayer 49 can be provided to add further treatments, such as silicone oil, additional coating, or fire retardants, to the exterior of the panel. The production line optionally includes vacuum pump/s 42 to remove excess water. Also included is a board an optional high-temperature kiln or oven 48 to facilitate panel drying.

### CLAUSES OF THE INVENTION

The following clauses describe various aspects of the invention.

Clause 1. A reinforced cement panel having an overall board density of about 40 to 80 pounds per cubic foot (0.64 to 1.28 g/cc), preferably about 45 to 65 pounds per cubic foot (0.72 to 1.04 g/cc), comprising:
a core layer of cementitious material having opposed planar surfaces and opposed edges and having a continuous phase resulting from the setting of an aqueous cementitious slurry having a pH greater than 9, comprising:
20-40 weight % water,
35-60 weight %, preferably 35-55 weight %, inorganic cement based binder, preferably Portland cement-based binder,
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice;
10-50 volume % entrained air, and
optionally, typically 0 to 10 wt. %, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
at least one outer layer of an woven or non-woven basalt fiber mesh reinforcement embedded in the opposed planar surfaces of the core layer,
wherein the basalt fiber mesh reinforcement is made from an uncoated basalt yarn or a coated basalt yarn,
wherein the uncoated basalt yarn consists essentially of basalt fibers and has a linear mass density in a range of 60 to 1200 Tex (grams per 1000 meters), and
wherein the coated basalt yarn comprises basalt fibers and a coating on the basalt fibers, wherein the basalt fibers have a linear mass density of 60 Tex to 1200 Tex (mass in grams per 1000 meters), and the coated basalt yarn comprises 50 to 70 wt. % coating, preferably 15 to 30 wt % coating, on a dry basis;
wherein the number of basalt yarns per inch in the cement panel is 2-8 yarns/inch in warp direction and 2-8 yarns/inch in weft direction.

Clause 2. The panel of clause 1, wherein the basalt yarns have a linear mass density of 80 Tex to 600 Tex, more preferably of 100 Tex to 300 Tex.

Clause 3. The panel of clause 1, wherein the basalt fiber mesh reinforcement is a woven mesh of said basalt fibers.

Clause 4. The panel of clause 1, 2 or 3, wherein the number of basalt yarns per inch in the cement panel is 6 yarns/inch or less, preferably 5 yarns/inch or less.

Clause 5. The panel of clause 1, 2 or 3, wherein the basalt fiber mesh reinforcement is a woven mesh scrim having 2×2 to 8×8, for example 2×2, 2×3, 3×3, 3×4, 4×4 to 6×6, strand per inch construction in longitudinal and transverse directions of the scrim, respectively.

Clause 6. The panel of clause 1, 2 or 3, wherein the panel comprises:
at least one outer layer of the basalt fiber mesh reinforcement on one pair of the opposed edges of the core, and
wherein the basalt fiber mesh reinforcement has a 4.0×4.0 strands per inch construction in both the lateral and transverse directions.

Clause 7. The panel of clause 1 or 2, wherein the basalt fiber mesh reinforcement is a non-woven mesh of said basalt fibers.

Clause 8. The panel of any of clauses 1 to 7, wherein the basalt yarns of the current invention are uncoated.

Clause 9. The panel of any of clauses 1 to 7, wherein the basalt yarns are coated with epoxy, PVC, acrylic, rubber, or other polymer.

Clause 10. The panel of any of clauses 1 to 7, wherein the basalt fiber mesh reinforcement is made from basalt fiber yarn coated with an alkali resistant coating selected from the group consisting of wax, polyvinyl chloride, polyvinyl alcohol, polyvinyl acetate, polyester, acrylics, acrylonitrile, silicones, styrene-butadiene, polypropylene, epoxy and polyethylene and mixtures thereof.

Clause 11. The panel of any of clauses 1 to 10, wherein the panel has a thickness of about ¼ to 1 inches (6.3 to 25.4 mm).

Clause 12. The panel of any of clauses 1 to 11, wherein the panel has top and bottom surfaces reinforced with basalt fiber mesh reinforcement.

Clause 13. The panel of any of clauses 1 to 12, wherein the panel has a density of 40 to 85 pcf (0.64 to 1.36 g/cc).

Clause 14. The panel of any of clauses 1 to 13, wherein the perlite filler has a mean particle diameter between 20-150 microns.

Clause 15. A method of making a cementitious panel of any of clauses 1 to 14 comprising,
forming an aqueous cementitious slurry having a pH greater than 9, by mixing, typically under conditions which provide an initial slurry temperature of at least about 40° F. (4.4° C.):
20-40 weight % water,
35-60 weight %, preferably 35-55 weight %, inorganic cement based binder, preferably Portland cement-based binder,
1 to 45 weight % filler, preferably 1 to 40 weight % filler, more preferably 2-10 weight % expanded and chemically coated perlite filler and 0-25 weight %, for example, 10-25 weight %, secondary filler typically selected from one or more of expanded clay, shale aggregate, and pumice;
10-50 volume % entrained air, and
optionally, typically 0 to 10 wt. %, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
placing a basalt fiber mesh reinforcement on a surface,
depositing the aqueous cementitious slurry on the basalt fiber mesh reinforcement on the surface by pouring the aqueous cementitious slurry through the basalt fiber mesh reinforcement to coat and embed the entire basalt fiber mesh reinforcement in the cementitious slurry before the aqueous cementitious slurry is set to form a core layer; and
setting the aqueous cementitious slurry to form the core layer, wherein the core layer has opposed planar surfaces and opposed edges, and at least one outer layer of said basalt fiber mesh reinforcement embedded between the opposed planar surfaces;
wherein the basalt fiber mesh reinforcement is made from an uncoated basalt yarn or a coated basalt yarn,
wherein the uncoated basalt yarn consists essentially of basalt fibers and has a linear mass density of 60 Tex to 1200 Tex (mass in grams per 1000 meters), and
wherein the coated basalt yarn comprises the basalt fibers and a coating on the basalt fibers, wherein the basalt fibers have a linear mass density of 60 Tex to 1200 Tex (mass in grams per 1000 meters), and wherein the coated basalt yarn comprises 50 to 70 wt. % coating, on a dry basis;
wherein the number of basalt yarns per inch in the cement panel is 2-8 yarns/inch in warp direction and 2-8 yarns/inch in weft direction.

Clause 16. The method of clause 15, further comprising applying a second basalt fiber mesh to the deposited aqueous cementitious slurry.

### EXAMPLE 1

### Alkali-Soak Strength Retention of Basalt Fibers

Alkali-soak strength retention of basalt fibers were evaluated using tensile strength retention under alkaline environment. The tensile strength testing was performed on single basalt yarn consisting of multiple basalt monofilaments. 8″ yarns were cut and epoxied on both the edges leaving a 1″ gauge length in the middle with no-epoxy. Single yarn was pulled in tension in the epoxy applied portion to induce break in the 1″ gauge length with no-epoxy.

For alkaline exposure single yarn was subjected to 1% sodium hydroxide for 3 hours to simulate extreme alkali environmental conditions. TABLE 3 shows tensile strength of a single uncoated basalt yarn using different thicknesses (264 Tex and 530 Tex) before alkaline exposure, after alkaline exposure and the % tensile strength retention. The tensile strength retention of uncoated basalt fibers was found to be ˜90%. Tex is a unit of measure for the linear mass density of fibers, yarns and thread and is defined as the mass in grams per 1000 meters.

TABLE 3
Tensile Strength (Ibf)

| | Before Alkaline | After Alkaline | |
|---|---|---|---|
| | Exposure (Ibf) | Exposure (Ibf) | Retention (%) |
| Basalt uncoated (264 Tex) | 31.1 | 27.7 | 89 |
| Basalt uncoated (530 Tex) | 64.6 | 58.6 | 91 |

FIG. 3 shows uncoated basalt yarns epoxied on the edges with tensile failure of the filaments in the non-epoxy portion.

### EXAMPLE 2

### Cement Panel with Coated Basalt Fiber as Reinforcement

In this example, the objective was to investigate the flexural response of the cementitious panels made using coated basalt mesh as reinforcement. The density of the cement panels cast was around 58 pcf. Cement panels half-inch thickness (12.7 mm) were cast to determine the flexural strength. Both top and bottom surfaces were reinforced with an epoxy coated basalt-fiber reinforced mesh. Epoxy coated basalt-fiber mesh with 264 Tex was used in machine direction and epoxy coated basalt-fiber mesh with 530 Tex was used in cross-machine direction. Tex is a unit of measure for the linear mass density of fibers, yarns and thread and is defined as the mass in grams per 1000 meters. The same composition as in Example 2 was used to produce 0.5 inch (1.27 cm) thick lightweight cement panels having a density of about 58 pounds per cubic foot (pcf) (0.93 g/cc). FIG. 6 shows the coated basalt mesh before the cement panel was cast. FIG. 7 shows the cement panel made using the coated basalt mesh.

Four-point bending tests were conducted according to the ASTM C 947 test method. The specimens were tested at 10″ span (254 mm). The testing was performed on a closed-loop MTS testing system. The load was applied at constant displacement rate of 0.5″/1 minute (12.7 mm/1 minute). The flexural properties were calculated according to the ASTM C 947 and ASTM C 1325 test methods. The flexural strength of the cement panel made using coated basalt fibers was found to be ˜450 psi.

Although the preferred embodiments for implementing the present invention are described, it will be understood by those skilled in the art to which this disclosure is directed that modifications and additions may be made to the invention.

1. A reinforced cement panel having an overall board density of about 40 to 80 pounds per cubic foot (0.64 to 1.28 g/cc), comprising:
a core layer of cementitious material having opposed planar surfaces and opposed edges and having a continuous phase resulting from the setting of an aqueous cementitious slurry having a pH greater than 9, comprising:
20-40 weight % water,
35-60 weight % inorganic cement based binder,
1 to 45 weight % filler, and 0-25 weight % secondary filler;
10-50 volume % entrained air, and
optionally, additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
at least one outer layer of an woven or non-woven basalt fiber mesh reinforcement embedded in the opposed planar surfaces of the core layer,
wherein the basalt fiber mesh reinforcement is made from an uncoated basalt yarn or a coated basalt yarn,
wherein the uncoated basalt yarn consists essentially of basalt fibers and has a linear mass density in a range of 60 to 1200 Tex (grams per 1000 meters), and
wherein the coated basalt yarn comprises basalt fibers and a coating on the basalt fibers, wherein the basalt fibers have a linear mass density of 60 Tex to 1200 Tex (mass in grams per 1000 meters), and the coated basalt yarn comprises 50 to 70 wt. % coating on a dry basis;
wherein the number of basalt yarns per inch in the cement panel is 2-8 yarns/inch in warp direction and 2-8 yarns/inch in weft direction.

2. The panel of claim 1, wherein the basalt yarns have a linear mass density of 80 Tex to 600 Tex.

3. The panel of claim 1, wherein the basalt fiber mesh reinforcement is a woven mesh of said basalt fibers.

4. The panel of claim 1, wherein the number of basalt yarns per inch in the cement panel is 6 yarns/inch or less.

5. The panel of claim 1, wherein the basalt fiber mesh reinforcement is a woven mesh scrim having 2×2 to 8×8 strand per inch construction in longitudinal and transverse directions of the scrim, respectively.

6. The panel of claim 1, wherein the panel comprises:
at least one outer layer of the basalt fiber mesh reinforcement on one pair of the opposed edges of the core, and
wherein the basalt fiber mesh reinforcement has a 4.0×4.0 strands per inch construction in both the lateral and transverse directions.

7. The panel of claim 1, wherein the basalt fiber mesh reinforcement is a non-woven mesh of said basalt fibers.

8. The panel of claim 1, wherein the basalt yarns of the current invention are uncoated.

9. The panel of claim 1, wherein the basalt yarns are coated with epoxy, PVC, acrylic, rubber, or other polymer.

10. The panel of claim 1, wherein the basalt fiber mesh reinforcement is made from basalt fiber yarn coated with an alkali resistant coating selected from the group consisting of wax, polyvinyl chloride, polyvinyl alcohol, polyvinyl acetate, polyester, acrylics, acrylonitrile, silicones, styrene-butadiene, polypropylene, epoxy and polyethylene and mixtures thereof.

11. The panel of claim 1, wherein the panel has a thickness of about ¼ to 1 inches (6.3 to 25.4 mm).

12. The panel of claim 1, wherein the panel has top and bottom surfaces reinforced with basalt fiber mesh reinforcement.

13. The panel of claim 1, wherein the panel has a density of 40 to 85 pcf (0.64 to 1.36 g/cc).

14. The panel of claim 1, wherein the perlite filler has a mean particle diameter between 20-150 microns.

15. A method of making a cementitious panel of claim 1 comprising,
forming an aqueous cementitious slurry having a pH greater than 9, by mixing, typically under conditions which provide an initial slurry temperature of at least about 40° F. (4.4° C.):
20-40 weight % water,
35-60 weight % inorganic cement based binder,
1 to 45 weight % filler, secondary filler;
10-50 volume % entrained air, and
optionally additives selected from one or more members of the group consisting of water reducing agents, chemical set-accelerators, chemical set-retarders, air-entraining agents, foaming agents, shrinkage control agents, coloring agents, viscosity modifying agents and thickeners, and internal curing agents; and
placing a basalt fiber mesh reinforcement on a surface,
depositing the aqueous cementitious slurry on the basalt fiber mesh reinforcement on the surface by pouring the aqueous cementitious slurry through the basalt fiber mesh reinforcement to coat and embed the entire basalt fiber mesh reinforcement in the cementitious slurry before the aqueous cementitious slurry is set to form a core layer; and
setting the aqueous cementitious slurry to form the core layer, wherein the core layer has opposed planar surfaces and opposed edges, and at least one outer layer of said basalt fiber mesh reinforcement embedded between the opposed planar surfaces;
wherein the basalt fiber mesh reinforcement is made from an uncoated basalt yarn or a coated basalt yarn,
wherein the uncoated basalt yarn consists essentially of basalt fibers and has a linear mass density of 60 Tex to 1200 Tex (mass in grams per 1000 meters), and
wherein the coated basalt yarn comprises the basalt fibers and a coating on the basalt fibers, wherein the basalt fibers have a linear mass density of 60 Tex to 1200 Tex (mass in grams per 1000 meters), and wherein the coated basalt yarn comprises 50 to 70 wt. % coating, on a dry basis;
wherein the number of basalt yarns per inch in the cement panel is 2-8 yarns/inch in warp direction and 2-8 yarns/inch in weft direction.

16. The method of claim 15, further comprising applying a second basalt fiber mesh to the deposited aqueous cementitious slurry.
